(19) United States
(12) Patent Application Publication
(10) Pub. No.: US 2015/0242907 A1
(43) Pub. Date: Aug. 27, 2015

(54) SYSTEMS AND METHODS FOR OPTIMIZING IMPRESSION FREQUENCY

(71) Applicant: Google Inc., Mountain View, CA (US)

(72) Inventor: Nicholas B. Wray, Mountain View, CA (US)

(73) Assignee: Google Inc., Mountain View, CA (US)

(21) Appl. No.: 14/191,274

(22) Filed: Feb. 26, 2014

(51) Int. Cl. G06Q 30/02

(52) U.S. Cl. CPC G06Q 30/0275; G06Q 30/0249

(57) ABSTRACT

Systems and methods for optimizing impression frequency for content presented on a client device are provided. A content distribution system selects a subset of available impressions on which to place bids such that a predetermined content distribution budget is spent and the bids are placed on impressions associated with a minimum number of unique user identifiers. The content distribution system receives a notification of an available impression for presenting content on a client device and identifies a user identifier associated with the client device. The content distribution system calculates a hash value for the user identifier as a function of the user identifier and compares the hash value with an impression probability threshold. The content distribution system determines whether to bid on the available impression based on a result of the comparison.

### BACKGROUND

The Internet provides access to a wide variety of content. Publishers of webpages and other types of first-party content often monetize their content by allowing sponsored third-party content (e.g., advertisements) to be integrated therewith. A programmatic Internet advertising system can be used to automate the selection and integration of third-party content with the first-party content. In certain programmatic Internet advertising systems, third-party content providers (e.g., advertisers) configure rules for placing bids on available impressions (i.e., opportunities to display an advertisement in conjunction with a webpage).

Third-party content providers often set budget constraints which limit the amount spent on third-party content. Budget constraints may be enforced by a budget throttling system. Budget throttling is a technique for selectively bidding on impressions to ensure that the total amount spent on third-party content does not exceed a budget limit. Previous budget throttling systems use a variety of different budget throttling schemes. However, previous budget throttling systems do not consider impression frequency with respect to a particular user identifier.

### SUMMARY

One implementation of the present disclosure is a method for optimizing impression frequency for content presented on a client device. The method includes receiving, at a computing system, a notification of an available impression for presenting content on a client device; identifying, by the computing system, a user identifier associated with the available impression; mapping, by the computing system, the user identifier to a calculated value within a normalized range, wherein the calculated value is a function of the user identifier; comparing, by the computing system, the calculated value with an impression probability threshold; and determining, by the computing system, whether to bid on the available impression based on a result of the comparison.

In some implementations, the calculated value is a hash value for the user identifier calculated as a function of the user identifier. The hash value may be uniformly distributed with respect to a plurality of different hash values within the normalized range. Each of the plurality of different hash values may be calculated as a function of a different user identifier.

In some implementations, the hash value for the user identifier is a function of both the user identifier and a campaign identifier associated with a content distribution campaign.

In some implementations, the hash value for the user identifier is a first hash value for the user identifier with respect to a first content distribution campaign. The method may further include calculating, by the computing system, a second hash value for the user identifier as a function of the user identifier with respect to a second content distribution campaign. The first hash value for the user identifier and the second hash value for the user identifier may be different.

In some implementations, the impression probability threshold is associated with a content distribution campaign. The method may further include calculating the impression probability threshold as a function of a content distribution budget for the campaign. In some implementations, calculating the impression probability threshold includes using content distribution parameters of the campaign to estimate a non-throttled spending rate for the campaign and using the content distribution budget and the non-throttled spending rate to determine a proportion of impressions which satisfy the content distribution parameters and on which bids can be placed without exceeding the content distribution budget.

In some implementations, determining whether to bid on the available impression includes determining to bid on the available impression in response to a determination that the hash value is less than the impression probability threshold and determining to not bid on the available impression in response to a determination that the hash value is not less than the impression probability threshold.

In some implementations, the method further includes classifying the user identifier as a throttled user identifier or a non-throttled user identifier with respect to a content distribution campaign based on a result of the comparison, delivering content associated with the campaign to the client device in response to classifying the user identifier as a non-throttled user identifier, and preventing content associated with the campaign from being delivered to the client device in response to classifying the user identifier as a throttled user identifier.

Another implementation of the present disclosure is a system for optimizing impression frequency for content presented on a client device. The system includes a computing system configured to receive notifications of available impressions for presenting content on a client device. The computing system is configured to identify, for each of the available impressions, a user identifier associated with the available impression. The computing system is configured to select a subset of the available impressions on which to place bids such that a predetermined content distribution budget is spent on winning bids and the bids are placed on impressions associated with a minimum number of unique user identifiers.

In some implementations, the computing system is configured to calculate, for each of the available impressions, a hash value for the associated user identifier as a function of the user identifier and to compare the hash value with an impression probability threshold. The computing system may select the subset of the available impressions based on a result of the comparison.

In some implementations, calculating the hash value for the user identifier includes normalizing the function of the user identifier to a value within a normalized range. The hash values for each of the user identifiers may be uniformly distributed within the normalized range. In some implementations, the hash value for the user identifier is a function of both the user identifier and a campaign identifier associated with a content distribution campaign.

In some implementations, the computing system is configured to calculate, for each of the available impressions, a first hash value for the associated user identifier with respect to a first content distribution campaign and a second hash value for the associated user identifier with respect to a second content distribution campaign. The first hash value and the second hash value may be functions of the user identifier and may have different values.

In some implementations, the impression probability threshold is associated with a content distribution campaign. The computing system may be configured to calculate the impression probability threshold as a function of a content distribution budget for the campaign. In some implementations, calculating the impression probability threshold includes using content distribution parameters of the campaign to estimate a non-throttled spending rate for the campaign and using the content distribution budget and the non-throttled spending rate to determine a proportion of impressions which satisfy the content distribution parameters and on which bids can be placed without exceeding the content distribution budget.

In some implementations, the computing system selects an available impression for inclusion in the subset of available impressions in response to a determination that the hash value for the user identifier associated with the available impression is less than the impression probability threshold.

In some implementations, the computing system is configured to classify, for each of the available impressions, the associated user identifier as a throttled user identifier or a non-throttled user identifier with respect to a content distribution campaign based on a result of the comparison. The computing system may be configured to deliver content associated with the campaign to a client device associated with the available impression in response to classifying the user identifier as a non-throttled user identifier.

Another implementation of the present disclosure is a system for optimizing impression frequency for content presented on a client device. The system includes a computing system configured to receive a notification of an available impression for presenting content on a client device and to identify a user identifier associated with the client device. The computing system is configured to calculate a hash value for the user identifier as a function of the user identifier and to compare the hash value with an impression probability threshold. The computing system is configured to determine whether to bid on the available impression based on a result of the comparison.

In some implementations, the computing system is configured to normalize function of the user identifier to a value within a normalized range. The hash value may be uniformly distributed with respect to a plurality of different hash values within the normalized range. Each of the plurality of different hash values may be calculated as a function of a different user identifier.

In some implementations, determining whether to bid on the available impression includes determining to bid on the available impression in response to a determination that the hash value is less than the impression probability threshold and determining to not bid on the available impression in response to a determination that the hash value is not less than the impression probability threshold.

The foregoing is a summary and thus by necessity contains simplifications, generalizations, and omissions of detail. Consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a block diagram of a computing system including a content distribution configured to optimize impression frequency for content presented on a client device, according to a described implementation.

FIG. 2 is a block diagram illustrating the content distribution system of FIG. 1 in greater detail, according to a described implementation.

FIG. 3 is a flowchart of a process for optimizing impression frequency for content presented on a client device, according to a described implementation.

### DETAILED DESCRIPTION

Referring generally to the FIGURES, systems and methods for optimizing impression frequency are shown, according to a described implementation. In an online content distribution system, it is often desirable to present content more than once to the same user. For example, increasing the frequency that a third-party content item (e.g., an advertisement) is presented to a user is likely to improve recall and increase brand awareness. Each presentation of content to the user may be represented by an impression event. Impression frequency for a content item or a group of content items (e.g., a campaign, an ad group, etc.) could be maximized by bidding on every available impression. However, third-party content providers often set budget constraints which limit an amount of money that the third-party content providers are willing to spend.

Budget constraints may be enforced by a budget throttling system. Budget throttling is a technique for selectively bidding on impressions to ensure that the total amount spent does not exceed a budget limit. Budget throttling also allows a third-party content provider to bid on impressions evenly over a time period rather than spending the entire content distribution budget as quickly as possible. A budget throttling system may control bidding in order to optimize spending (e.g., bidding on a subset of impressions with a high predicted click through rate or high auction competitiveness, distributing the spending evenly throughout a time period, etc.) while satisfying budget constraints.

A content distribution campaign may have a natural spending rate (Z), which can be expressed as a monetary amount per time period (e.g., dollars per day). Spending rate Z may depend on various campaign parameters (e.g., bid prices, selection criteria, keywords, geographic limiters, temporal limiters, etc.) which control the circumstances under which content associated with the campaign can be distributed to client devices. The content distribution campaign may also have a budget (B), which can also be expressed as a monetary amount per time period. If the spending rate is greater than the budget (i.e., if Z>B), the campaign will tend to overspend its budget.

The systems and methods described herein may be used to select a subset of impressions on which bids can be placed in order to ensure that the amount spent does not exceed the budget. For example, a content distribution system in accordance with the present disclosure may calculate an impression probability for a particular campaign. The impression probability (IP) may be a ratio of the content distribution budget to the natural spending rate

$$( e . g . , IP = \frac{B}{Z} ) .$$

For campaigns in which the natural spending rate exceeds the budget (i.e., Z>B), the impression probability may be between zero and one (e.g., 0.2, 0.85, etc.). By bidding on only

$$\frac{B}{Z}$$

(e.g., 20%, 85%, etc.) of available impressions, the budged amount B may be spent evenly throughout the time period for which it is allocated.

The subset of impressions on which bids are placed may be selected to optimize an impression frequency for a set of client devices and/or user identifiers with respect to content associated with a particular campaign. For example, the client devices and/or user identifiers that receive content items associated with the campaign may each receive a maximum number of such content items. In other words, the content distribution system may select the subset of impressions such that the content distribution budget B is spent on impressions associated with a minimum number of unique user identifiers (e.g., spreading the available spending over the smallest set of user identifiers while still spending the budget).

In some implementations, a content distribution system receives a notification of an available impression from a client device. The notification of the available impression may include a user identifier (e.g., a cookie ID, a device ID, a user agent, a profile ID, etc.) associated with the impression. The content distribution system may identify the user identifier associated with the available impression.

The content distribution system may calculate a hash value as a function of the user identifier. The hash value may be normalized to a value within a normalized range (e.g., between zero and one, inclusive). For any given campaign, the set of hash values for various user identifiers may be uniformly distributed within the normalized range. For example, for a normalized range from zero to one, 40% of user identifiers may have a corresponding hash value less than 0.4, 80% of user identifiers may have a corresponding hash value less than 0.8, etc.

In some implementations, the hash value is a function of the user identifier and a campaign ID. Using the campaign ID to calculate the hash value may ensure that the same user identifier can result in a different hash value for different campaigns. Each hash value may correspond to a particular combination of a user identifier and a campaign ID.

The content distribution system may compare the hash value for the user identifier with the impression probability value for a particular campaign. If the hash value is greater than the impression probability, the impression may be throttled for the campaign (i.e., the campaign may not bid on the impression). If the hash value is less than the impression probability, the impression may not be throttled for the campaign (i.e., the campaign may bid on the impression) In this way, content from a particular campaign may be distributed only to user identifiers which have hash values less than the impression probability for the campaign.

Using the user identifier to calculate the hash value may ensure that user identifiers are randomly distributed between throttled user identifiers and non-throttled user identifiers, proportional to the impression probability. For example, a campaign with an impression probability of 0.45 may result in a distribution of 45% of total user identifiers in the set of non-throttled user identifiers and 55% of total user identifiers in the set of throttled user identifiers. For implementations in which the impression probability does not change, a campaign may consistently bid in either every auction for a particular user identifier or no auctions for the user identifier (e.g., based on whether the hash value for the user identifier is less than or greater than the impression probability). This spreads the bidding and impressions over the smallest set of users while still spending the budget. For implementations in which the impression probability changes over time, the campaign may determine whether to bid in an auction associated with a particular user identifier based on whether the hash value for the user identifier is greater than or less than the impression probability at the time of the auction.

Using the campaign ID to calculate the hash value may ensure that the set of user identifiers that one campaign bids on is statistically independent from the set of user identifiers bid on by all other campaigns. In various implementations, other randomizing factors may be used other than the campaign ID to ensure that hash values for user identifiers are not correlated. In some implementations, an impression probability multiplier is applied to the impression probability for a campaign for user identifiers that have already received content associated with the campaign. The impression probability multiplier may increase the impression probability only for user identifiers that have previously received content from the campaign.

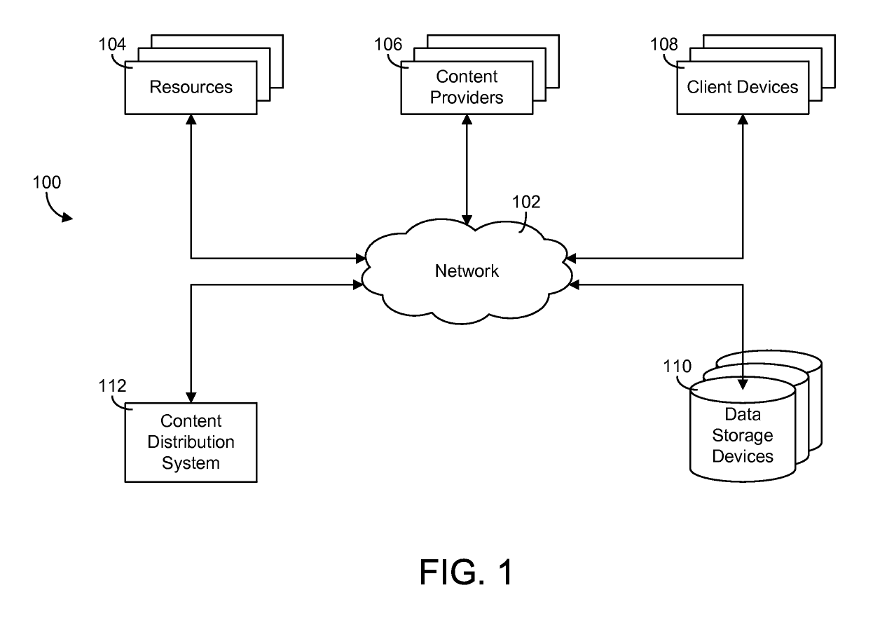

Referring now to FIG. 1, a block diagram of a computing system 100 is shown, according to a described implementation. In brief overview, computing system 100 is shown to include a network 102, resources 104, content providers 106, client devices 108, data storage devices 110, and a content distribution system 112. It should be noted that although the various components of computing system 100 are shown and described separately with reference to FIG. 1, in some implementations, one or more components of computing system 100 may be combined into a single component. For example, data storage devices 110 may be a component of content distribution system 112, resources 104, content providers 106, and/or client devices 108. As another example, the functions of resources 104 and content providers 106 may be performed by a single entity.

Computing system 100 may facilitate communication between resources 104, content providers 106, and client devices 108. For example, client devices 108 may request and receive first-party resource content (e.g., web pages, documents, etc.) from resources 104 via network 102. In some implementations, resources 104 include content slots for presenting third-party content items from content providers 106. When resource content is viewed by client devices 108, third-party content items from content providers 106 may be delivered and presented in the content slots of resources 104.

Computing system 100 may also facilitate communication between resources 104, content providers 106, client devices 108, and content distribution system 112. For example, content distribution system 112 may receive a notification of an available impression from client devices 108 when resource content from resources 104 (e.g., a first webpage) is loaded and/or viewed by client devices 108. Content distribution system 112 may select one or more third-party content items (e.g., advertisements provided by content providers 106) and deliver the selected content items to client devices 108.

Still referring to FIG. 1, and in greater detail, computing system 100 is shown to include a network 102. Network 102 may be a local area network (LAN), a wide area network (WAN), a cellular network, a satellite network, a radio network, the Internet, or any other type of data network or combination thereof. Network 102 may include any number of computing devices (e.g., computers, servers, routers, network switches, etc.) configured to transmit, receive, or relay data. Network 102 may further include any number of hardwired and/or wireless connections. For example, client devices 108 may communicate wirelessly (e.g., via WiFi, cellular, radio, etc.) with a transceiver that is hardwired (e.g., via a fiber optic cable, a CAT5 cable, etc.) to a computing device of network 102.

Still referring to FIG. 1, computing system 100 is shown to include resources 104. Resources 104 may include any type of information or data structure that can be provided over network 102. In some implementations, resources 104 may be identified by a resource address associated with each resource (e.g., a uniform resource locator (URL)). Resources 104 may include websites, webpages (e.g., HTML webpages, PHP webpages, etc.), word processing documents, portable document format (PDF) documents, images, video, programming elements, interactive content, streaming video/audio sources, or other types of electronic information.

Resources 104 may include first-party content provided by various publishers. For example, a publisher may operate a website which includes a plurality of webpages (e.g., a first webpage, a second webpage, etc.). The website and the webpages may be part of resources 104. Publishers may interact with content distribution system 112 to elect whether to display third-party content in association with various webpages of resources 104.

Resources 104 may include a variety of content elements. For example, content elements may include, textual content elements (e.g., text boxes, paragraph text, text snippets, etc.), image content elements (e.g., pictures, graphics, etc.), video content elements (e.g., streaming video, moving graphics, etc.), hyperlink content elements (e.g., links to webpages, links to other resources, etc.), or any other type of content element that is rendered when resources 104 are viewed and/or loaded by client devices 108.

In some implementations, resources 104 include content slots for presenting third-party content items. For example, resources 104 may include one or more inline frame elements (e.g., HTML “iframe” elements, <iframe> . . . </iframe>) for presenting third-party content items from content providers 106. An inline frame can be a target frame for links defined by other elements and can be selected by user agents (e.g., client devices 108, a web browser running on client devices 108, etc.) as the focus for printing, viewing its source, or other forms of user interaction. The content slots may cause client devices 108 to request third-party content items in response to viewing first-party resource content from resources 104.

Various elements of resources 104 may be included in the original content of resources 104 or added to resources 104. For example, some elements of resources 104 may be part of the source code of resources 104. Other elements of resources 104 may be added by content providers 106, content distribution system 112, and/or client devices 108. For example, resources 104 may include a tag (e.g., a “show_ads” tag) which causes client devices 108 to request additional content from content distribution system 112 when resources 104 are rendered or viewed by client devices 108. Additional content may include third-party content items, computer-readable instructions, configuration information, tag firing rules, or other content which can be inserted into resources 104. In various implementations, the additional content may be inserted into an existing frame of resources 104 or a new element may be created for the additional content. For example, client devices 108 may create and/or insert a new <ins> element in the document object model (DOM) of resources 104.

Resources 104 may include elements (e.g., tags, script elements, etc.) which have embedded information (e.g., meta-information embedded in hyperlinks) and/or embedded instructions. Embedded instructions may include computer-readable instructions (e.g., software code, JavaScript®, ECMAScript®, etc.) which are executed by client devices 108 (e.g., by a web browser running on client devices 108). Computer-readable instructions may be included in the original (i.e., source) content of resources 104 or added to resources 104 when rendered by client devices 108.

Still referring to FIG. 1, computing system 100 is shown to include content providers 106. Content providers 106 may include one or more electronic devices representing advertisers, business owners, advertising agencies, or other entities capable of generating third-party content to be presented along with first-party content from resources 104. In some implementations, content providers 106 produce third-party content items (e.g., an ad creative) for presentation to client devices 108. In other implementations, content providers 106 may submit a request to have third-party content items automatically generated. The third-party content items may be stored in one or more data storage devices local to content providers 106, within content distribution system 112, or in data storage devices 110.

In some implementations, the third-party content items are advertisements. The advertisements may be display advertisements such as image advertisements, animated advertisements, moving picture advertisements, audio advertisements, video advertisements, text-based advertisements, or any combination thereof. In other implementations, the third-party content items may include other types of content which serve various non-advertising purposes.

In some implementations, third-party content items include interstitial content. Interstitial content may include advertisements which are displayed temporally between two resources. For example, when a user clicks a link from a first resource to a second resource, an interstitial advertisement may be shown to the user before the second resource is displayed. Interstitial content can also be used to introduce another page or site, to inform a user that the next page requires a login or is part of a different domain, or for a variety of other informational and/or promotional uses.

In some implementations, content providers 106 submit campaign parameters to content distribution system 112. The campaign parameters may be used to control the distribution of third-party content items to client devices 108. The campaign parameters may include keywords associated with the third-party content items, bids corresponding to the keywords, a content distribution budget, geographic limiters, or other criteria used by content distribution system 112 to determine when a third-party content item may be presented to client devices 108.

Content providers 106 may access content distribution system 112 to monitor the performance of the third-party content items distributed according to the established campaign parameters. For example, content providers 106 may access content distribution system 112 to review one or more behavior metrics associated with a third-party content item or set of third-party content items. The behavior metrics may describe the interactions between client devices 108 with respect to a distributed third-party content item or set of third-party content items (e.g., number of impressions, number of clicks, number of conversions, an amount spent, etc.). The behavior metrics may be based on user actions logged and processed by an accounting system or a log file processing system.

Still referring to FIG. 1, computing system 100 is shown to include client devices 108. Client devices 108 may include any number and/or type of user-operable electronic devices. For example, client devices 108 may include desktop computers, laptop computers, smartphones, tablets, mobile communication devices, remote workstations, client terminals, entertainment consoles, or any other devices capable of interacting with the other components of computing system 100 (e.g., via a communications interface). Client devices 108 may be capable of receiving resource content from resources 104 and/or third-party content items from content providers 106 or content distribution system 112. Client devices 108 may include mobile devices or non-mobile devices.

In some implementations, client devices 108 include an application (e.g., a web browser, a resource renderer, etc.) for converting electronic content into a user-comprehensible format (e.g., visual, aural, graphical, etc.). Client devices 108 may include a user interface element (e.g., an electronic display, a speaker, a keyboard, a mouse, a microphone, a printer, etc.) for presenting content to a user, receiving user input, or facilitating user interaction with electronic content (e.g., clicking on a content item, hovering over a content item, etc.). Client devices 108 may function as a user agent for allowing a user to view HTML encoded content.

Client devices 108 may include a processor capable of processing embedded information (e.g., meta information embedded in hyperlinks, etc.) and executing embedded instructions. Embedded instructions may include computer-readable instructions (e.g., software code, JavaScript®, ECMAScript®, etc.) associated with a content slot within which a third-party content item is presented. For example, client devices 108 load one or more embedded tags (e.g., a “show_ads” tag) in conjunction with resource content from resources 104. An embedded tag may include computer-readable instructions which cause client devices 108 to request a third-party content item from content distribution system 112 when the instructions are executed by client devices 108.

In some implementations, client devices 108 are capable of detecting an interaction with a distributed content item. An interaction with a content item may include displaying the content item, hovering over the content item, clicking on the content item, viewing source information for the content item, or any other type of interaction between client devices 108 and a content item. Interaction with a content item does not require explicit action by a user with respect to a particular content item. In some implementations, an impression (e.g., displaying or presenting the content item) may qualify as an interaction. The criteria for defining which user actions (e.g., active or passive) qualify as an interaction may be determined on an individual basis (e.g., for each content item), by content providers 106, or by content distribution system 112.

Client devices 108 may generate a variety of user actions. For example, client devices 108 may generate a user action in response to a detected interaction with a content item. The user action may include a plurality of attributes including a content identifier (e.g., a content ID or signature element), a device identifier, a referring URL identifier, a timestamp, or any other attributes describing the interaction. Client devices 108 may generate user actions when particular actions are performed (e.g., resource views, online purchases, search queries submitted, etc.). The user actions generated by client devices 108 may be communicated to content distribution system 112 or a separate accounting system.

For situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated (e.g., by content distribution system 112) in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, a user may have control over how information is collected (e.g., by an application, by client devices 108, etc.) and used by content distribution system 112.

Still referring to FIG. 1, computing system 100 is shown to include data storage devices 110. Data storage devices 110 may be any type of memory device capable of storing profile data, content item data, accounting data, or any other type of data used by content distribution system 112 or another component of computing system 100. Data storage devices 110 may include any type of non-volatile memory, media, or memory devices. For example, data storage devices 110 may include semiconductor memory devices (e.g., EPROM, EEPROM, flash memory devices, etc.) magnetic disks (e.g., internal hard disks, removable disks, etc.), magneto-optical disks, and/or CD ROM and DVD-ROM disks.

In some implementations, data storage devices 110 are local to content distribution system 112, resources 104, client devices 108, or content providers 106. In other implementations, data storage devices 110 are remote data storage devices connected with content distribution system 112 and/or other components of computing system 100 via network 102. In some implementations, data storage devices 110 are part of a data storage server or system capable of receiving and responding to queries from content distribution system 112 and/or client devices 108.

Still referring to FIG. 1, computing system 100 is shown to include a content distribution system 112. Content distribution system 112 may receive a notification of an available impression from resources 104 and/or client devices 108. The notification of an available impression may be received in response to first-party content from resources 104 being viewed and/or loaded by client devices 108. For example, when client devices load resource content from resources 104, client devices 108 may also load one or more embedded tags (e.g., code snippets) that cause client devices 108 to send a notification of an available impression to content distribution system 112. The notification of an available impression may include a request for third-party content. Content distribution system 112 may be configured to identify a particular resource with which the third-party content item will be displayed (e.g., by URL, by domain name, etc.) and/or a user identifier associated with the request (e.g., a cookie ID, a device ID, a profile ID, etc.). Content distribution system 112 may select a third-party content item and deliver the selected third-party content item to client devices 108.

Content distribution system 112 may calculate a hash value as a function of the user identifier. Content distribution system 112 may normalize the hash value to a value within a normalized range (e.g., between zero and one, inclusive). For any given campaign, the set of hash values for various user identifiers may be uniformly distributed within the normalized range. For example, for a normalized range from zero to one, 40% of user identifiers may have a corresponding hash value less than 0.4, 80% of user identifiers may have a corresponding hash value less than 0.8, etc. In some implementations, the hash value is a function of the user identifier and a campaign ID. Using the campaign ID to calculate the hash value may ensure that the same user identifier can result in a different hash value for different campaigns. Each hash value may correspond to a particular combination of a user identifier and a campaign ID.

Content distribution system 112 may compare the hash value for the user identifier with the impression probability value for a particular campaign. If the hash value is greater than the impression probability, content distribution system 112 may throttle the impression (e.g., by not placing and/or disallowing a bid on the impression from the campaign). If the hash value is less than the impression probability, content distribution system 112 may not throttle the impression (e.g., by placing and/or allowing a bid to be placed on the impression from the campaign). An impression may be throttled or not throttled with respect to a particular campaign. For example, the same impression may be throttled with respect to a first campaign and not throttled with respect to a second campaign. In some implementations, content distribution system 112 causes a campaign to place bids on all non-throttled impressions for the campaign and prevents the campaign from bidding on throttled impressions for the campaign. In this way, content from a particular campaign may be distributed only to user identifiers which have hash values less than the impression probability for the campaign.

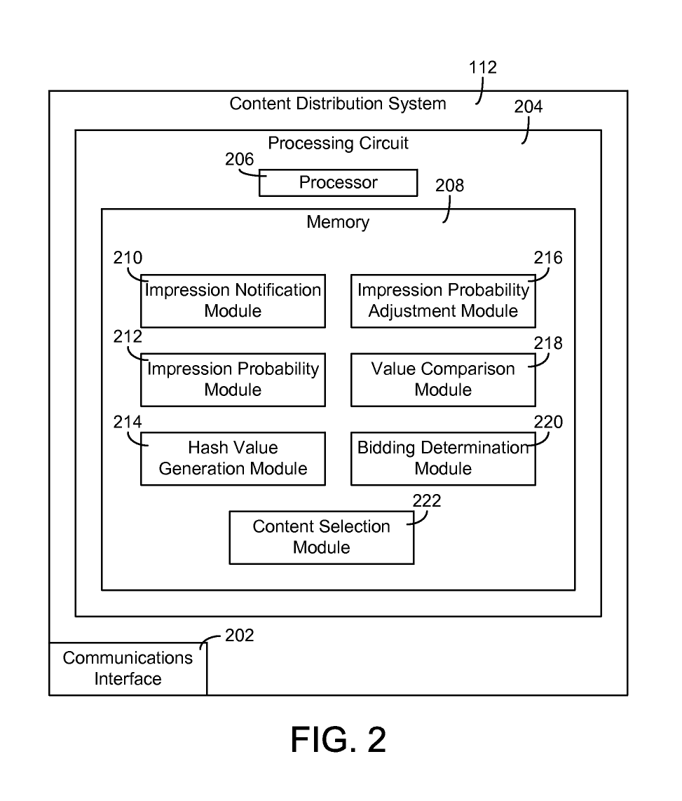

Referring now to FIG. 2, a block diagram illustrating content distribution system 112 in greater detail is shown, according to a described implementation. Content distribution system 112 is shown to include a communications interface 202 and a processing circuit 204. Communications interface 202 may include wired or wireless interfaces (e.g., jacks, antennas, transmitters, receivers, transceivers, wire terminals, Ethernet ports, WiFi transceivers, etc.) for conducting data communications with local or remote devices or systems. For example, communications interface 202 may allow content distribution system 112 to communicate with resources 104, content providers 106, client devices 108, network 102, and/or data storage devices 110.

Processing circuit 204 is shown to include a processor 206 and memory 208. Processor 206 may be implemented as a general purpose processor, an application specific integrated circuit (ASIC), one or more field programmable gate arrays (FPGAs), a CPU, a GPU, a group of processing components, or other suitable electronic processing components.

Memory 208 may include one or more devices (e.g., RAM, ROM, flash memory, hard disk storage, etc.) for storing data and/or computer code for completing and/or facilitating the various processes, layers, and modules described in the present disclosure. Memory 208 may include volatile memory or non-volatile memory. Memory 208 may include database components, object code components, script components, or any other type of information structure for supporting the various activities and information structures described in the present disclosure. In some implementations, memory 208 is communicably connected to processor 206 via processing circuit 204 and includes computer code (e.g., data modules stored in memory 208) for executing one or more processes described herein. Memory 208 is shown to include an impression notification module 210, an impression probability module 212, a hash value generation module 214, an impression probability adjustment module 216, a value comparison module 218, a bidding determination module 220, and a content selection module 222.

Still referring to FIG. 2, memory 208 is shown to include an impression notification module 210. Impression notification module 210 may be configured to receive a notification of an available impression from a first-party resource (e.g., resources 104) and/or from client devices 108. For example, first-party resources may include one or more content slots for presenting third-party content items. The content slots may cause first-party resources to request a third-party content item when loaded by client devices 108.

In some implementations, impression notification module 210 receives a notification of an available impression from client devices 108. For example, when client devices 108 load a first-party resource, an embedded content slot in the first-party resource (e.g., an embedded tag, a “show_ads” tag, etc.) may cause client devices 108 to request a third-party content item from content distribution system 112. Client devices 108 may notify impression notification module 210 of an available impression by requesting a third-party content item from content distribution system 112.

In some implementations, the notification of the available impression includes an indication of the first-party resource with which the third-party content item will be presented. For example, the notification of the available impression may include a webpage URL, a document URL, a domain name, or other indication of a particular first-party resource.

In some implementations, the notification of the available impression includes an indication of a user identifier. For example, the user identifier may be a cookie ID, a device ID, a profile ID, or other identifier of a particular user or client device from which the request for third-party content is received. The user identifier may indicate a user or client device associated with the notification of the available impression. For example, the user identifier may identify a client device to which a third-party content item will be delivered in response to the notification of the available impression.

Impression notification module 210 may be configured to identify the user identifier associated with the available impression. In some implementations, impression notification module 210 stores the user identifier (e.g., in data storage devices 110). In some implementations, impression notification module 210 provides the user identifier to hash value generation module 214 for use in calculating a hash value.

Still referring to FIG. 2, memory 208 is shown to include an impression probability module 212. Impression probability module 212 may be configured to identify the natural spending rate (Z) and the content distribution budget (B) for various content distribution campaigns. For example, a content distribution campaign may have a natural spending rate Z, which can be expressed as a monetary amount per time period (e.g., dollars per day). Spending rate Z may depend on various campaign parameters (e.g., bid prices, selection criteria, keywords, geographic limiters, temporal limiters, etc.) which control the circumstances under which content associated with the campaign can be distributed to client devices.

The content distribution campaign may also have a budget B, which can also be expressed as a monetary amount per time period. In various implementations, budget B may be provided to content distribution system 112 by content providers 106 or calculated based on other information (e.g., a budget for a longer time period, an amount already spent in the current time period, etc.). If the spending rate is greater than the budget (i.e., if Z>B), the campaign will tend to overspend its budget.

Impression probability module 212 may be configured to calculate an impression probability value for various content distribution campaigns. In some implementations, the impression probability value for a campaign is a function of a natural spending rate Z and/or a content distribution budget B for the campaign. For example, impression probability module 212 may calculate the impression probability (IP) for a campaign as a ratio of the content distribution budget to the natural spending rate

$$( e . g . , IP = \frac{B}{Z} ) .$$

For campaigns in which the natural spending rate exceeds the budget (i.e., Z>B), the impression probability may be between zero and one (e.g., 0.2, 0.85, etc.).

The impression probability may define a proportion of available impressions (e.g., impressions which satisfy the campaign parameters) on which a campaign can bid without exceeding the content distribution budget B. By bidding on only

$$\frac{B}{Z}$$

(e.g., 20%, 85%, etc.) of available impressions, the budged amount B may be spent evenly throughout the time period for which it is allocated. Impression probability module 212 may store the impression probability in memory and/or provide the impression probability to value comparison module 218 for use in determining whether to bid on the available impression.

Still referring to FIG. 2, memory 208 is shown to include a hash value generation module 214. Hash value generation module 214 may be configured to generate a hash value for an available impression. Hash value generation module 214 may generate a hash value for a user identifier and/or an available impression with respect to a particular campaign. The same user identifier and/or available impression may have multiple different hash values, each hash value corresponding to a particular campaign. For example, the hash value may be a function of a particular user identifier and/or a particular campaign ID.

The user identifier used by hash value generation module 214 to generate the hash value may be the user identifier associated with the available impression (e.g., the user identifier to which a third-party content item will be delivered in response to the request for content). The campaign ID may identify a particular content item, grouping of content items (e.g., an ad group), content distribution campaign (e.g., a collection of ad groups and/or content items), content provider (e.g., an advertiser, an advertising agency, etc.), or other information that can be used to identify a set of content items. In some implementations, the campaign ID identifies the particular content distribution campaign for which the impression probability was calculated by impression probability module 212.

In some implementations, hash value generation module 214 normalizes the hash value to a value within a normalized range (e.g., between zero and one, inclusive). For any given campaign, the set of hash values for various user identifiers may be uniformly distributed within the normalized range. For example, for a normalized range from zero to one, 40% of user identifiers may have a corresponding hash value less than 0.4, 80% of user identifiers may have a corresponding hash value less than 0.8, etc.

By using the user identifier to calculate the hash value, hash value generation module 214 can ensure that the corresponding users and/or client devices are randomly distributed between throttled and non-throttled, proportional to the impression probability. For example, a campaign with an impression probability of 0.45 may result in a distribution of 45% of total user identifiers in the set of non-throttled user identifiers and 55% of total user identifiers in the set of throttled user identifiers.

By using the campaign ID (or some other randomizing factor) to calculate the hash value (e.g., in addition to the user identifier) hash value generation module 214 may ensure that the same user identifier can result in a different hash value for different campaigns. For example, the same user identifier may have a relatively low hash value (e.g., 0.13) for a first campaign and a relatively higher hash value (e.g., 0.82) for a second campaign. Without the campaign ID (or some other randomizing factor), hash value generation module 214 may generate the same hash value for a user identifier for multiple different campaigns. By using the campaign ID (or some other randomizing factor) to calculate the hash value, hash value generation module 214 may ensure that the set of impressions on which a campaign will bid is statistically independent from the set of impressions bid on by all other campaigns.

In various implementations, other randomizing factors may be used (e.g., other than the campaign ID) to ensure that hash values for user identifiers are not correlated between campaigns. However, the same user identifier may always have the same hash value for the same campaign. A campaign may consistently bid in either every auction for a particular user identifier or no auctions for the user identifier (e.g., based on whether the hash value for the user identifier is less than or greater than the impression probability). This spreads the bidding and impressions over the smallest set of users while still spending the budget.

Still referring to FIG. 2, memory 208 is shown to include an impression probability adjustment module 216. Impression probability adjustment module 216 may be configured to adjust the impression probability value IP calculated by impression probability module 212. For example, impression probability adjustment module 216 may generate an impression probability multiplier (m) which can be applied to the impression probability value IP. In various implementations, the impression probability multiplier m may be greater than one (e.g., m=1.1, m=1.4, etc.) or less than one (e.g., m=0.9, m=0.6, etc.). Impression probability adjustment module 216 may be configured to multiply the impression probability IP by the impression probability multiplier m to calculate an adjusted impression probability value (I′P) (e.g., I′P=IP*m).

Impression probability adjustment module 216 may be configured to adjust the impression probability IP to ensure that the allocated budget B is spent. Without adjusting the impression probability IP, it is possible that a campaign could underspend its budget B due to user identifiers hitting frequency caps (e.g., a maximum number of content items per unit time). For example, a campaign may consistently bid in either every auction for a user identifier (e.g., if the hash value associated with the user identifier is less than the impression probability value) or no auctions for a user identifier (e.g., if the hash value associated with the user identifier is greater than the impression probability value). If a user identifier in the subset of non-throttled user identifiers hits a frequency cap, the bids that would have been submitted in auctions associated with that user identifier may be unspent.

Impression probability adjustment module 216 may be configured to increase the impression probability IP (e.g., by multiplying IP by a value greater than one) to increase a number of user identifiers in the subset of non-throttled user identifiers. For example, a larger impression probability value IP may result in more hash values being less than the impression probability value IP, thereby increasing the number of non-throttled user identifiers. In some implementations, impression probability adjustment module 216 increases the impression probability value for a campaign only for user identifiers that have previously received content from the campaign. In this way, impression probability adjustment module 216 may cause some user identifiers that have previously received content from the campaign to be included in the set of non-throttled user identifiers.

Still referring to FIG. 2, memory 208 is shown to include a value comparison module 218. Value comparison module 218 may be configured to compare the impression probability value for a campaign with the hash value (HV) associated with an available impression (e.g., the hash value for a user identifier associated with the available impression). Value comparison module 218 may determine whether the hash value HV is less than the impression probability value IP (e.g., HV<IP) or not less than the impression probability value IP (e.g., HV≧IP). Value comparison module 218 may store and/or output a result of the comparison.

Still referring to FIG. 2, memory 208 is shown to include a bidding determination module 220. Bidding determination module 220 may be configured to determine whether to bid on an available impression based on the result of the comparison performed by value comparison module 218. For example, if value comparison module 218 determines that the hash value for an available impression is less than the impression probability value for a campaign (e.g., HV<IP), bidding determination module 220 may determine that the campaign should bid on the available impression. If value comparison module 218 determines that the hash value for an available impression is not less than the impression probability value for a campaign (e.g., HV≧IP), bidding determination module 220 may determine that the campaign should not bid on the available impression. In this way, content from a particular campaign may be distributed only to user identifiers that have hash values less than the impression probability value for the campaign.

Still referring to FIG. 2, memory 208 is shown to include a content selection module 222. Content selection module 222 may be configured to select a third-party content item to deliver to client devices 108 to fill the available impression. In some implementations, content selection module 222 exposes the available impression to content providers 106. Content selection module 222 may auction the available impression to content providers 106. In some implementations, content selection module 222 selects an eligible third-party content item based on a result of the auction. For example, content selection module 22 may select an eligible content item associated with the content provider that submits the highest bid.

Content selection module 222 may generate a quality signal for the available impression. The quality signal may be based on one or more indications of an estimated return on investment associated with the impression (e.g., an established click-through-rate, a predicted click-through-rate, etc.). The quality signal may be a general quality signal for the identified resource, a particular quality signal for the available impression, or an individualized quality signal for the available impression and a particular third-party content item. Content selection module 222 may provide the quality signal to content providers 106 to consider when bidding on the available impression.

In some implementations, content selection module 222 identifies a particular resource with which the third-party content item will be displayed (e.g., by URL, by domain name, etc.). In some implementations, content selection module 222 selects a third-party content item that is relevant to the first-party resource content in conjunction with which the third-party content item will be presented (e.g., based on the content of the first resource). Content selection module 222 may select a third-party content item by comparing the keywords associated with the content item (e.g., specified by content providers 106, additional keywords extracted from the content item, etc.) with the keywords associated with the first resource. A topic or type of content included in resources 104 may be used to establish keywords for resources 104.

In some implementations, content selection module 222 selects a third-party content item by considering whether the content item is relevant to the client device 108 to which the content item will be presented. For example, content selection module 222 may compare the keywords associated with the content item with information (e.g., profile data, user preferences, etc.) associated with a particular client device 108 requesting the content item.

In some implementations, content selection module 222 selects a third-party content item which has characteristics matching the characteristics of a content slot in which the content item will be presented. For example, content selection module 222 may select a content item having a display size which fits in a destination content slot. Content selection module 222 may resize a selected content item to fit a content slot or add additional visual content to the selected content item (e.g., padding, a border, etc.) based on the display size of the content item and the display size of the content slot. In some implementations, eligible content items include content items matching established user preferences for receiving individualized content; however, content selection module 222 may select a content item that does not match established user preferences if an insufficient number of preferred content items are available.

Content selection module 222 may deliver the selected third-party content item to client devices 108 for presentation in association with content from resources 104. The third-party content item may be displayed alongside first-party content from resources 104.

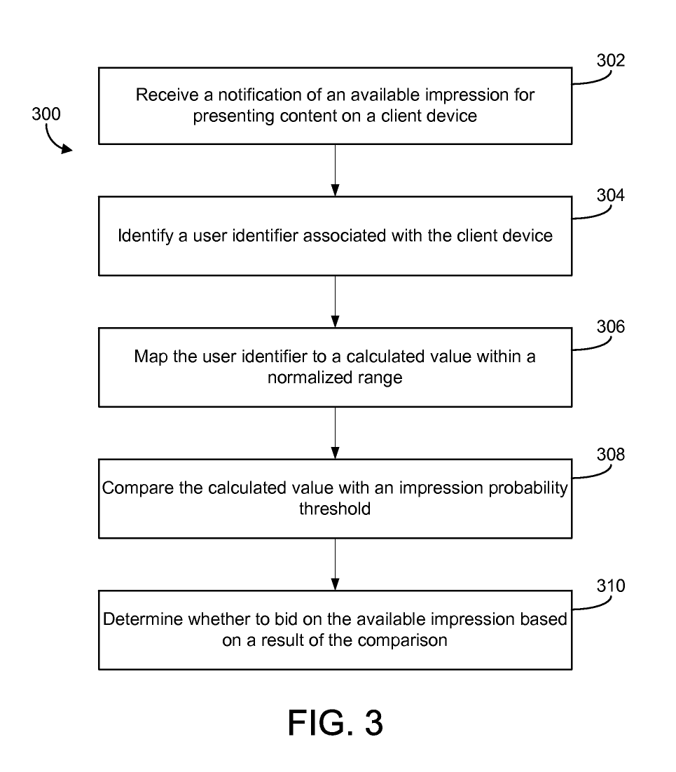

Referring now to FIG. 3, a flowchart of a process 300 for optimizing impression frequency for content presented on a client device is shown, according to a described implementation. In some implementations, process 300 is performed by content distribution system 112 as described with reference to FIGS. 1-2. Process 300 may be used to select a subset of available impressions on which a campaign will place bids such that a predetermined content distribution budget is spent on the bids and the bids are placed on impressions associated with a minimum number of unique user identifiers. In other words, process 300 may be used to maximize a per-user identifier impression frequency for user identifiers that receive content from a particular campaign.

Process 300 is shown to include receiving a notification of an available impression for presenting content on a client device (step 302). In some implementations, step 302 is performed by impression notification module 210 as described with reference to FIG. 2. In some implementations, step 402 may be performed by impression notification module 310 as described with reference to FIG. 3.

The notification of an available impression may be received from client devices 108 in conjunction with a request for third-party content. For example, when client devices 108 load a first-party resource, an embedded content slot in the first-party resource (e.g., an embedded tag, a “show_ads” tag, etc.) may cause client devices 108 to request a third-party content item from content distribution system 112. Client devices 108 may notify content distribution system 112 of an available impression by requesting a third-party content item from content distribution system 112. The notification of the available impression may include an indication of the first-party resource with which the third-party content item will be presented. For example, the notification of the available impression may include a webpage URL, a document URL, a domain name, or other indication of a particular first-party resource.

Still referring to FIG. 3, process 300 is shown to include identifying a user identifier associated with the client device (step 304). In some implementations, the notification of the available impression includes an indication of a user identifier. For example, the user identifier may be a cookie ID, a device ID, a profile ID, or other identifier of a particular user or client device from which the request for third-party content is received. The user identifier may indicate a user or client device associated with the notification of the available impression. For example, the user identifier may identify a client device to which a third-party content item will be delivered in response to the notification of the available impression.

Step 304 may include identifying the user identifier associated with the available impression. In some implementations, step 304 includes storing the user identifier (e.g., in data storage devices 110). In some implementations, step 304 includes providing the user identifier to hash value generation module 214 for use in calculating a hash value.

Still referring to FIG. 3, process 300 is shown to include mapping the user identifier to a calculated value within a normalized range (step 306). The calculated value may be a hash value for the user identifier and may be calculated as a function of the user identifier. In some implementations, step 306 is performed by hash value generation module 214 as described with reference to FIG. 2. Step 306 may include generating a hash value for a user identifier and/or an available impression with respect to a particular campaign. The same user identifier and/or available impression may have multiple different hash values, each hash value corresponding to a particular campaign. For example, the hash value may be a function of a particular user identifier and/or a particular campaign ID.

The user identifier used in step 306 to generate the hash value may be the user identifier associated with the available impression (e.g., the user identifier to which a third-party content item will be delivered in response to the request for content). The campaign ID used in step 306 may identify a particular content item, grouping of content items (e.g., an ad group), content distribution campaign (e.g., a collection of ad groups and/or content items), content provider (e.g., an advertiser, an advertising agency, etc.), or other information that can be used to identify a set of content items. In some implementations, the campaign ID identifies a particular content distribution campaign having an associated impression probability value.

In some implementations, step 306 includes normalizing the hash value to a value within a normalized range (e.g., between zero and one, inclusive). For any given campaign, the set of hash values for various user identifiers may be uniformly distributed within the normalized range. For example, for a normalized range from zero to one, 40% of user identifiers may have a corresponding hash value less than 0.4, 80% of user identifiers may have a corresponding hash value less than 0.8, etc.

Using the user identifier to calculate the hash value in step 306 may ensure that the corresponding users and/or client devices are randomly distributed between throttled and non-throttled, proportional to the impression probability. For example, a campaign with an impression probability of 0.45 may result in a distribution of 45% of total user identifiers in the set of non-throttled user identifiers and 55% of total user identifiers in the set of throttled user identifiers.

Using the campaign ID (or some other randomizing factor) to calculate the hash value (e.g., in addition to the user identifier) in step 306 may ensure that the same user identifier can result in a different hash value for different campaigns. For example, the same user identifier may have a relatively low hash value (e.g., 0.13) for a first campaign and a relatively higher hash value (e.g., 0.82) for a second campaign. Without the campaign ID (or some other randomizing factor), hash value generation module 214 may generate the same hash value for a user identifier for multiple different campaigns. Using the campaign ID (or some other randomizing factor) to calculate the hash value in step 306 may ensure that the set of impressions on which a campaign will bid is statistically independent from the set of impressions bid on by all other campaigns.

In various implementations, other randomizing factors may be used in step 306 (e.g., other than the campaign ID) to ensure that hash values for user identifiers are not correlated between campaigns. However, the same user identifier may always have the same hash value for the same campaign. A campaign may consistently bid in either every auction for a particular user identifier or no auctions for the user identifier (e.g., based on whether the hash value for the user identifier is less than or greater than the impression probability). This spreads the bidding and impressions over the smallest set of users while still spending the budget.

Still referring to FIG. 3, process 300 is shown to include comparing the hash value with an impression probability threshold (step 308). In some implementations, step 308 is performed by value comparison module 218 as described with reference to FIG. 2. Step 308 may include comparing the impression probability value for a campaign with the hash value (HV) associated with the available impression notified in step 302 (e.g., the hash value for a user identifier associated with the available impression). Step 308 may include determining whether the hash value HV is less than the impression probability value IP (e.g., HV<IP) or not less than the impression probability value IP (e.g., HV≧IP). Step 308 may include storing and/or outputting a result of the comparison.

Still referring to FIG. 3, process 300 is shown to include determining whether to bid on the available impression based on a result of the comparison (step 310). In some implementations, step 310 is performed by bidding determination module 220 as described with reference to FIG. 2. Step 310 may include determining whether to bid on the available impression based on the result of the comparison performed in step 308. For example, if the comparison performed in step 308 reveals that the hash value for the available impression is less than the impression probability value for a campaign (e.g., HV<IP), step 310 may include determining that the campaign should bid on the available impression. If the comparison performed in step 308 reveals that the hash value for the available impression is not less than the impression probability value for a campaign (e.g., HV≧IP), step 310 may include determining that the campaign should not bid on the available impression. In this way, content from a particular campaign may be distributed only to user identifiers that have hash values less than the impression probability value for the campaign.

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate components or media (e.g., multiple CDs, disks, or other storage devices). Accordingly, the computer storage medium is both tangible and non-transitory.

The operations described in this disclosure may be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products embodied on one or more tangible media.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The construction and arrangement of the systems and methods as shown in the various illustrated implementations are examples only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions and arrangement of the exemplary implementations without departing from the scope of the present disclosure.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for optimizing impression frequency for content presented on a client device, the method comprising:
receiving, at a computing system, a notification of an available impression for presenting content on a client device;
identifying, by the computing system, a user identifier associated with the available impression;
mapping, by the computing system, the user identifier to a calculated value within a normalized range, wherein the calculated value is a function of the user identifier;
comparing, by the computing system, the calculated value with an impression probability threshold; and
determining, by the computing system, whether to bid on the available impression based on a result of the comparison.

2. The method of claim 1, wherein the calculated value is a hash value calculated for the user identifier as a function of the user identifier;
wherein the hash value is uniformly distributed with respect to a plurality of different hash values within the normalized range;
wherein each of the plurality of different hash values is calculated as a function of a different user identifier.

3. The method of claim 1, wherein the calculated value is a function of both the user identifier and a campaign identifier associated with a content distribution campaign.

4. The method of claim 1, wherein the impression probability threshold is associated with a content distribution campaign, the method further comprising:
calculating the impression probability threshold as a function of a content distribution budget for the campaign.

5. The method of claim 4, wherein calculating the impression probability threshold comprises:
using content distribution parameters of the campaign to estimate a non-throttled spending rate for the campaign; and
using the content distribution budget and the non-throttled spending rate to determine a proportion of impressions which satisfy the content distribution parameters and on which bids can be placed without exceeding the content distribution budget.

6. The method of claim 4, further comprising:
determining whether the identified user identifier has previously received content associated with the content distribution campaign; and
increasing the impression probability threshold in response to a determination that the identified user identifier has previously received content associated with the content distribution campaign.

7. The method of claim 1, wherein determining whether to bid on the available impression comprises:
determining to bid on the available impression in response to a determination that the calculated value is less than the impression probability threshold; and
determining to not bid on the available impression in response to a determination that the calculated value is not less than the impression probability threshold.

8. The method of claim 1, further comprising:
classifying the user identifier as a throttled user identifier or a non-throttled user identifier with respect to a content distribution campaign based on a result of the comparison;
delivering content associated with the campaign to the client device in response to classifying the user identifier as a non-throttled user identifier; and
preventing content associated with the campaign from being delivered to the client device in response to classifying the user identifier as a throttled user identifier.

9. A system for optimizing impression frequency for content presented on a client device, the system comprising:
a computing system configured to receive notifications of available impressions for presenting content on a client device;
wherein the computing system is configured to identify, for each of the available impressions, a user identifier associated with the available impression;
wherein the computing system is configured to select a subset of the available impressions on which to place bids such that a predetermined content distribution budget is spent on winning bids and the bids are placed on impressions associated with a minimum number of unique user identifiers.

10. The system of claim 9, wherein the computing system is configured to calculate, for each of the available impressions, a hash value for the associated user identifier as a function of the user identifier and to compare the hash value with an impression probability threshold;
wherein the computing system selects the subset of the available impressions based on a result of the comparison.

11. The system of claim 10, wherein calculating the hash value for the user identifier comprises normalizing the function of the user identifier to a value within a normalized range;
wherein the hash values for each of the user identifiers are uniformly distributed within the normalized range.

12. The system of claim 10, wherein the hash value for the user identifier is a function of both the user identifier and a campaign identifier associated with a content distribution campaign.

13. The system of claim 9, wherein the computing system is configured to calculate, for each of the available impressions, a first hash value for the associated user identifier with respect to a first content distribution campaign and a second hash value for the associated user identifier with respect to a second content distribution campaign;
wherein the first hash value and the second hash value are functions of the user identifier and have different values.

14. The system of claim 10, wherein the impression probability threshold is associated with a content distribution campaign;
wherein the computing system is configured to calculate the impression probability threshold as a function of a content distribution budget for the campaign.

15. The system of claim 14, wherein calculating the impression probability threshold comprises:
using content distribution parameters of the campaign to estimate a non-throttled spending rate for the campaign; and
using the content distribution budget and the non-throttled spending rate to determine a proportion of impressions which satisfy the content distribution parameters and on which bids can be placed without exceeding the content distribution budget.

16. The system of claim 10, wherein the computing system selects an available impression for inclusion in the subset of available impressions in response to a determination that the hash value for the user identifier associated with the available impression is less than the impression probability threshold.

17. The system of claim 10, wherein the computing system is configured to classify, for each of the available impressions, the associated user identifier as a throttled user identifier or a non-throttled user identifier with respect to a content distribution campaign based on a result of the comparison;
wherein the computing system is configured to deliver content associated with the campaign to a client device associated with the available impression in response to classifying the user identifier as a non-throttled user identifier.

18. A system for optimizing impression frequency for content presented on a client device, the system comprising:
a computing system configured to receive a notification of an available impression for presenting content on a client device and to identify a user identifier associated with the available impression;
wherein the computing system is configured to map the user identifier to a calculated value within a normalized range and to compare the calculated value with an impression probability threshold, wherein the calculated value is a function of the user identifier;
wherein the computing system is configured to determine whether to bid on the available impression based on a result of the comparison.

19. The system of claim 18, wherein the calculated value is a hash value calculated for the user identifier as a function of the user identifier;
wherein the hash value is uniformly distributed with respect to a plurality of different hash values within the normalized range;
wherein each of the plurality of different hash values is calculated as a function of a different user identifier.

20. The system of claim 18, wherein determining whether to bid on the available impression comprises:
determining to bid on the available impression in response to a determination that the calculated value is less than the impression probability threshold; and
determining to not bid on the available impression in response to a determination that the calculated value is not less than the impression probability threshold.
